(19) United States
(12) Patent Application Publication
(10) Pub. No.: US 2025/0362651 A1
(43) Pub. Date: Nov. 27, 2025

(54) HOT SWAP BASE FOR A BUILDING CONTROLLER

(71) Applicant: Honeywell International Inc., Charlotte, NC (US)

(72) Inventor: MICHAEL ZHENG, Beijing (CN)

(21) Appl. No.: 18/672,802

(22) Filed: May 23, 2024

(51) Int. Cl. G05B 15/02; G06F 13/42

(52) U.S. Cl. CPC G05B 15/02; G06F 13/4282; G06F 2213/0002

(57) ABSTRACT

A controller receiving base for receiving a controller. The receiving base includes a housing having a first side and an opposing second side. The housing defines a controller receiving slot for receiving a controller. The receiving base includes a conductor assembly. When the controller receiving slot receives a controller of a first type, the controller may deflect a deflectable part of the conductor assembly to form an electrical break in a conduction path between a first terminal accessible from the first side of the housing and a second terminal accessible from the second side of the housing. When the controller receiving slot receives a controller of a second type, the building controller may not deflect the deflectable part of the conductor assembly such that the conductor assembly maintains the conduction path between the first terminal and the second terminal.

### TECHNICAL FIELD

The present disclosure relates generally to controllers, and more particularly to methods and systems for mounting and/or connecting such controllers.

### BACKGROUND

Automation, process control, and other systems often employ controllers and/or other devices to control various aspects of the system. Automation systems can include, for example, Building Automation Systems (BAS). BAS systems can include, for example, Heating, Ventilation and/or Air Conditioning (HVAC) systems, security systems, access control systems, fire systems, lighting systems, and/or any other suitable building control system. Process control systems can include industrial process control systems for controlling part or all of an industrial process. Industrial processes can include, for example, chemical processes such as oil refining processes, chemical production processes, distilling processes, food production processes, electronic production processes, robotic processes, and/or any other suitable industrial process. These are just examples.

It is often desirable to replace failed or failing controllers and/or upgrade legacy controllers during routine or urgent maintenance of a system. Replacing and/or upgrading controllers can require that the system be powered down and/or taken off-line, which can be disruptive, costly and time consuming. What would be desirable are methods and systems for hot swapping controllers of a system in a more efficient and convenient manner.

### SUMMARY

The present disclosure relates generally to controllers, and more particularly to methods and systems for mounting and/or connecting controllers such that the controllers can be hot swapped in an efficient and convenience manner.

In a first example, a building controller receiving base for receiving a building controller may comprise a housing having a first side and an opposing second side, the housing defining a building controller receiving slot for receiving a building controller, the building controller receiving slot situated between the first side and the second side of the housing and defined at least in part by a slot defining wall and a conductor assembly. When the building controller receiving slot receives a building controller of a first building controller type, the building controller of the first building controller type may deflect a deflectable part of the conductor assembly to form an electrical break in a conduction path between a first terminal accessible from the first side of the housing and a second terminal accessible from the second side of the housing. When the building controller receiving slot receives a building controller of a second building controller type, the building controller of the second building controller type may not deflect the deflectable part of the conductor assembly such that the conductor assembly maintains the conduction path between the first terminal and the second terminal.

Alternatively or additionally to any of the examples above, in another example, when the building controller receiving slot receives the building controller of the first building controller type, the conductor assembly may provide a first conduction path from the first terminal accessible from the first side of the housing to a first port of the building controller of the first building controller type, and may provide a second conduction path from the second terminal accessible from the second side of the housing to a second port of the building controller of the first building controller type.

Alternatively or additionally to any of the examples above, in another example, when the building controller receiving slot receives the building controller of the second building controller type, the conductor assembly may provide an electrical connection to a port of the building controller of the second building controller type such that the port of the building controller of the first building controller type is electrically connected to both the first terminal accessible from the first side of the housing and the second terminal accessible from the second side of the housing through the conduction path.

Alternatively or additionally to any of the examples above, in another example, the deflectable part of the conductor assembly may include a touch flake that extends into the building controller receiving slot. When the building controller of the first building controller type is inserted into the building controller receiving slot, one of the first port and second port of the building controller of the first building controller type may be configured to electrically engage the touch flake and mechanically deflect the deflectable part of the conductor assembly to electrically break the conduction path between the first terminal accessible from the first side of the housing and the second terminal accessible from the second side of the housing.

Alternatively or additionally to any of the examples above, in another example, the building controller of the first building controller type may use the first port and the second port of the building controller of the first building controller type to provide communication signals along a communication path having a first communication protocol between the first terminal accessible from the first side of the housing and the second terminal accessible from the second side of the housing and the building controller of the second building controller type may use the port of the building controller of the second building controller type to provide communication signals along a communication path having a second communication protocol between the first terminal accessible from the first side of the housing and the second terminal accessible from the second side of the housing.

Alternatively or additionally to any of the examples above, in another example, the first communication protocol may be TIL, and the second communication protocol may be RS485.

Alternatively or additionally to any of the examples above, in another example, the first terminal may comprise a first touch flake extending out from the first side of the housing, the second terminal may comprise a second touch flake extending out from the second side of the housing, and a third touch flake electrically coupled to the first terminal may extend into the building controller receiving slot.

Alternatively or additionally to any of the examples above, in another example, a fourth touch flake may be electrically coupled to the second terminal extending into the building controller receiving slot.

Alternatively or additionally to any of the examples above, in another example, when the building controller receiving slot receives the building controller of the first building controller type, the third touch flake and the fourth touch flake may be configured to electrically and mechanically engage a first port and a second port of the building controller of the first building controller type, respectively and when the building controller receiving slot receives the building controller of the second building controller type, the third touch flake may be configured to electrically and mechanically engage a port of the building controller of the second building controller type while the fourth touch flake may be configured to not be mechanically engaged by the building controller of the second building controller type.

In another example, a method for receiving a building controller in a building controller receiving base may comprise receiving a building controller of a building controller by the building controller receiving base. When the building controller is of a first building controller type, the method may further comprise deflecting a deflectable part of a conductor assembly of the building controller receiving base to electrically break a conduction path between a first terminal accessible from a first side of the building controller receiving base and a second terminal accessible from a second side of the building controller receiving base. When the building controller is of a second building controller type, the method may further comprise not deflecting the deflectable part of a conductor assembly of the building controller receiving base to not electrically break the conduction path between the first terminal accessible from the first side of the building controller receiving base and the second terminal accessible from the second side of the building controller receiving base.

Alternatively or additionally to any of the examples above, in another example, when the building controller is of the first building controller type, the conductor assembly may provide a first conduction path from the first terminal accessible from the first side of the building controller receiving base to a first port of the building controller of the first building controller type and may provide a second conduction path from the second terminal accessible from the second side of the building controller receiving base to a second port of the building controller of the first building controller type.

Alternatively or additionally to any of the examples above, in another example, when the building controller is of the second building controller type, the conductor assembly may provide an electrical connection to a port of the building controller of the second building controller type such that the port of the building controller of the first building controller type is electrically connected to both the first terminal accessible from the first side of the building controller receiving base and the second terminal accessible from the second side of the building controller receiving base through the conduction path.

Alternatively or additionally to any of the examples above, in another example, the building controller of the first building controller type may use the first port and the second port of the building controller of the first building controller type to provide communication signals along a communication path having a first communication protocol between the first terminal accessible from the first side of the building controller receiving base and the second terminal accessible from the second side of the building controller receiving base and the building controller of the second building controller type may use the port of the building controller of the second building controller type to provide communication signals along a communication path having a second communication protocol between the first terminal accessible from the first side of the building controller receiving base and the second terminal accessible from the second side of the building controller receiving base.

Alternatively or additionally to any of the examples above, in another example, the first communication protocol may be TIL and the second communication protocol may be RS485.

Alternatively or additionally to any of the examples above, in another example, the first terminal of the building controller receiving base may comprise a first touch flake extending out from the first side of the building controller receiving base, the second terminal of the building controller receiving base may comprise a second touch flake extending out from the second side of the building controller receiving base, a third touch flake may be electrically coupled to the first terminal of the building controller receiving base and configured to electrically connect to the first port of the building controller of the first building controller type, and a fourth touch flake may be electrically coupled to the second terminal of the building controller receiving base and configured to electrically connect to the second port of the building controller of the first building controller type.

In another example, a building controller receiving base for receiving a building controller may comprise a housing having a first side and an opposing second side, the housing defining a building controller receiving slot for receiving a building controller, the building controller receiving slot situated between the first side and the second side of the housing and defined at least in part by a slot defining wall, a first touch flake extending out from the first side of the housing, a second touch flake extending out from the second side of the housing, a first slot touch flake extending out from the slot defining wall and into the building controller receiving slot, a second slot touch flake extending out from the slot defining wall and into the building controller receiving slot, and a conductor assembly. When the building controller receiving slot receives a building controller of a first building controller type, the building controller of the first building controller type is may be to engage the first slot touch flake and the second slot touch flake, and the second slot touch flake when engaged deflects a deflectable part of the conductor assembly, With the deflectable part of the conductor assembly deflected, the conductor assembly may be configured to electrically connect the first touch flake and the first slot touch flake, electrically connect the second slot touch flake and the second touch flake, and electrically disconnect the first touch flake and the first slot touch flake from the second slot touch flake and the second touch flake. When the building controller receiving slot receives a building controller of a second building controller type, the building controller of the second building controller type may be configured to engage the first slot touch flake but not engage the second slot touch flake so that the second slot touch flake does not deflect the deflectable part of the conductor assembly. With the deflectable part of the conductor assembly not deflected, the conductor assembly may be configured to electrically connect the first touch flake, the first slot touch flake, the second slot touch flake and the second touch flake.

Alternatively or additionally to any of the examples above, in another example, when the building controller receiving slot receives the building controller of the first building controller type, the first slot touch flake may be configured to electrically connect to a first port of the building controller of the first building controller type and the second slot touch flake may be configured to electrically connect to a second port of the building controller of the first building controller type.

Alternatively or additionally to any of the examples above, in another example, when the building controller receiving slot receives the building controller of the second building controller type, the first slot touch flake may be configured to electrically connect to a port of the building controller of the second building controller type and the second slot touch flake may be configured to not electrically or mechanically engage the building controller of the second building controller type.

Alternatively or additionally to any of the examples above, in another example, the building controller of the first building controller type may be configured to use the first port and the second port of the building controller of the first building controller type to provide communication signals along a communication path having a first communication protocol between the first touch flake and the second touch flake and the building controller of the second building controller type is configured to use the first port of the building controller of the second building controller type to provide communication signals along a communication path having a second communication protocol between the first touch flake and the second touch flake.

Alternatively or additionally to any of the examples above, in another example, the first communication protocol may be TIL and the second communication protocol may be RS485.

The preceding summary is provided to facilitate an understanding of some of the features of the present disclosure and is not intended to be a full description. A full appreciation of the disclosure can be gained by taking the entire specification, claims, drawings, and abstract as a whole.

### BRIEF DESCRIPTION OF THE DRAWINGS

The disclosure may be more completely understood in consideration of the following description of various illustrative embodiments of the disclosure in connection with the accompanying drawings, in which:

FIG. 1 is a perspective view of an illustrative controller and an illustrative I/O device operatively coupled to one another through an intervening receiving base, wherein the intervening receiving base does not currently receive an intervening electronic device;

FIG. 2 is a perspective view of the illustrative controller of FIG. 1;

FIG. 3 is a perspective view of the illustrative I/O device of FIG. 1;

FIG. 4A is a perspective view of an illustrative but non-limiting receiving base from a first side;

FIG. 4B is a perspective view of the illustrative receiving base of FIG. 4A from a second side;

FIG. 5 is a perspective view of the illustrative receiving base of FIG. 4A with a front housing removed;

FIG. 6A is an exploded perspective view of one of the first plurality of electrical conductor assemblies of FIG. 5;

FIG. 6B is an assembled perspective view of one of the first plurality of electrical conductor assemblies of FIG. 6A;

FIG. 7A is an exploded side view of one of the second plurality of electrical conductor assemblies of FIG. 5;

FIG. 7B is an assembled side view of one of the second plurality of electrical conductor assemblies of Figurer 7A;

FIG. 8 is a schematic partial cross-sectional view of a building controller of a first building controller type received within the receiving slot of a receiving base; and

FIG. 9 is a schematic view of an illustrative receiving base having a building controller of a first type disposed within the receiving slot and electrically coupled with another receiving base free from an electronic device.

While the disclosure is amenable to various modifications and alternative forms, specifics thereof have been shown by way of example in the drawings and will be described in detail. It should be understood, however, that the intention is not to limit aspects of the disclosure to the particular illustrative embodiments described. On the contrary, the intention is to cover all modifications, equivalents, and alternatives falling within the spirit and scope of the disclosure.

### DESCRIPTION

The following description should be read with reference to the drawings wherein like reference numerals indicate like elements. The drawings, which are not necessarily to scale, are not intended to limit the scope of the disclosure. In some of the figures, elements not believed necessary to an understanding of relationships among illustrated components may have been omitted for clarity.

All numbers are herein assumed to be modified by the term “about”, unless the content clearly dictates otherwise. The recitation of numerical ranges by endpoints includes all numbers subsumed within that range (e.g., 1 to 5 includes 1, 1.5, 2, 2.75, 3, 3.80, 4, and 5).

As used in this specification and the appended claims, the singular forms “a”, “an”, and “the” include the plural referents unless the content clearly dictates otherwise. As used in this specification and the appended claims, the term “or” is generally employed in its sense including “and/or” unless the content clearly dictates otherwise.

It is noted that references in the specification to “an embodiment”, “some embodiments”, “other embodiments”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is contemplated that the feature, structure, or characteristic may be applied to other embodiments whether or not explicitly described unless clearly stated to the contrary.

It is contemplated that the present electronic device receiving base may be used to connect one or more suitable electrical devices of, for example, an automation, process control, and/or other system. However, to help illustrate, the present electrical connector is described with reference to an automation and/or process control system, such as a Building Automation Systems (BAS). Such systems may include a controller and a plurality of electrical control devices or input/output (I/O) devices. In some instances, the controller may include control circuitry and logic configured to operate, control, command, etc. various components of the Building Automation Systems (BAS). In some cases, the controller may provide these instructions to I/O devices or modules, which may in turn relay the control commands to various components of the Building Automation Systems (BAS). In some instances, the various components of the Building Automation Systems (BAS) may provide information related to the system, such as sensor readings, environmental conditions, etc. to the I/O devices, which in turn relay some or all of this information to the controller. In some cases, the controller and/or I/O devices may be mounted along a DIN rail, bus bar, or other mounting arrangement. To facilitate control of the various devices and/or communication therebetween, the controller, I/O devices, and/or various components may be electrically and communicatively coupled to one another. To facilitate coupling and uncoupling of the devices, it may be desirable to provide the electronic devices with more than one option for electrically coupling the devices to one another. In some cases, it may be desirable to swap out devices without stopping, powering down, and/or restarting the control system (e.g., hot swap devices). Further, it may be desirable to facilitate the coupling and uncoupling of the devices without having to move other electrical devices that are mounted adjacent to the controller on a DIN rail or the like. Additionally, it may be desirable to accommodate devices which utilize different communication types. These are just examples.

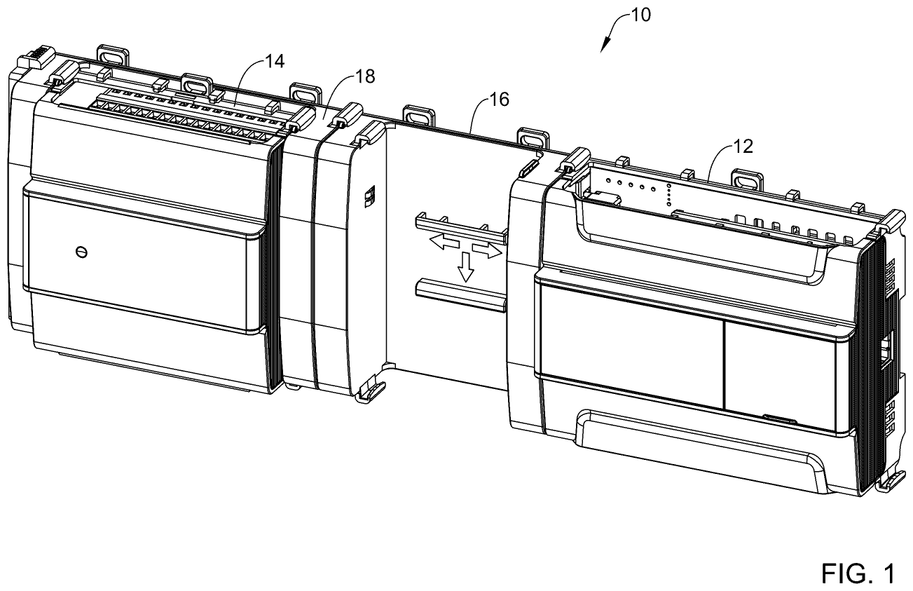

FIG. 1 is a perspective view of an illustrative but non-limiting modular controller assembly 10 including a controller 12, an I/O device 14, a first receiving base 16, and a second receiving base 18. While the controller 12 is not shown received by a corresponding receiving base in FIG. 1, it is contemplated that the controller 12 may be received by a third receiving base that is operatively coupled to the first receiving base 16, similar to that shown for I/O device 14. Moreover, while FIG. 1 is shown and described as having a controller 12 and an I/O device 14, the modular controller assembly 10 may include any number of controllers, I/O devices, and/or other electronic devices, as desired. The features described herein may be applied to controllers, process devices, actuators, valves, sensors, etc. The controller 12, I/O device 14, first receiving base 16, and second receiving base 18 (and third receiving base when present) may be electrically and mechanically coupled to provide control signals to various components of a system. The controller assembly 10 may include any number of controllers, I/O devices, other electronic devices, and/or receiving bases as desired.

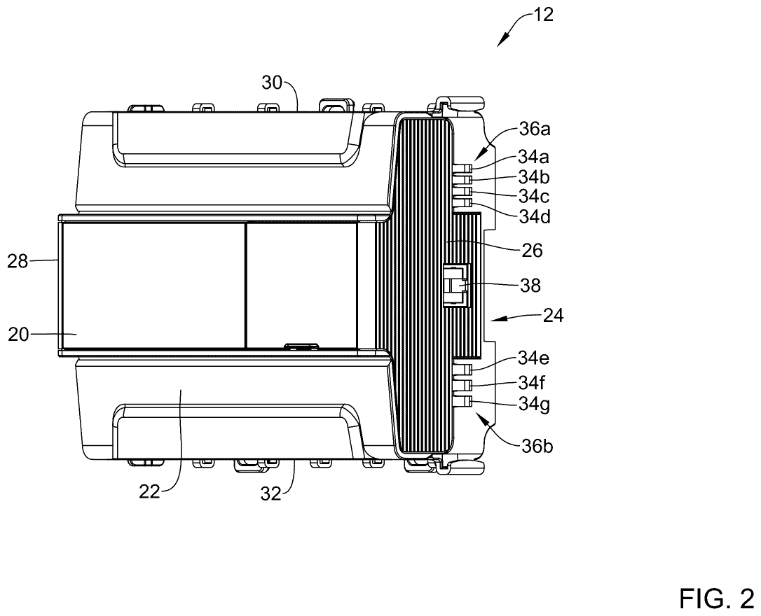

FIG. 2 is a perspective view of the illustrative controller 12 of FIG. 1. The controller 12 may include a housing 20 including a front side 22, a back side 24, and at least a first side 26, and a second opposing side 28. The first and second sides 26, 28 may each extend from or between the front 22 to the back 24. The housing 20 may further include a top 30 and an opposing bottom 32. The top and bottom 30, 32 may extend from or between the first and second sides 26, 28. The use of the terms “front”, “back”, “first”, “second”, “top”, and “bottom” are not intended to limit the controller 12 to a particular orientation, but rather to facilitate discussion of relative orientation. Further, the housing 20 is not limited to a rectangular or generally rectangular structure. Other shapes may be used for the housing 20, as desired. Some illustrative electronic devices and electrical connectors are described in commonly assigned U.S. patent application Ser. No. 16/837,579, filed on Apr. 1, 2020, and titled ELECTRICAL CONNECTOR FOR A CONTROLLER, and U.S. patent application Ser. No. 18/291,067, filed on Jan. 22, 2024, and titled HOT SWAP BASE FOR A BUILDING CONTROLLER, the disclosures of which are hereby incorporated by reference.

The illustrative controller 12 may include a printed circuit board (PCB) (not shown). The PCB may be completely or partially housed within the housing 20. While not explicitly shown, the PCB may include electrical and/or electronic components that may include control logic and/or communication capabilities. These components may be electrically connected to one another and mechanically fastened to the PCB. While not explicitly shown, the controller 12 may include pins, terminal connectors, etc. for coupling the PCB to other devices.

The illustrative controller 12 may include one or more electrical connectors 34a-g (collectively, 34). Each of the electrical connectors 34 may be electrically connected to the

PCB (not shown) via a terminal receiving slot or other electrical connection (not explicitly shown) and may be configured to electrically couple the PCB of the controller 12 to other external devices. The controller 12 may include any number of electrical connectors 34 as desired. The electrical connectors 34 may be grouped together to form ports 36a-b (collectively, 36). In some cases, a first set of ports 36a-b may be formed on the first side 26 of the controller 12 and an opposing set of ports (not explicitly shown) may be formed on the second side 28 of the controller 12. For example, the number of electrical connectors 34 provided may depend on how the controller 12 is to be connected to another electronic device. For example, a first port type may require three electrical connectors to form a port 36b. A first electrical connector 34e of the port 36b may be for power, a second electrical connector 34f of the port 36b may be for ground, and a third electrical connector 34g of the port 36b may be for serial data. Another port type (e.g., RS485) may require six electrical connectors to form two ports 36a, 36b. The first port 36a may be for power while the second port 36b is for data. These are just examples. In some cases, each of the electrical connectors 34 may extend from a first terminal (e.g. first touch flake) adjacent to or accessible from the first side 26 of the housing 20 to a second terminal (e.g. second touch flake) adjacent to or accessible from the second side 28 of the housing 20 such that each group of electrical connectors (e.g., 34a-d and 34e-g) forms two ports, respectively. It should be understood that the ports 36a, 36b provided on the first side 26 may be electrically connected to a first device while the ports (not explicitly shown) on the second side 28 may be electrically connected to a second, different device. For example, the ports 36a, 36b may be for receiving an input and/or delivering an output from a first external device while the ports on the opposing side may be for receiving an input and/or delivering an output to a second or different external device. In some cases, only two of the ports may be provided. For example, two of the ports (e.g., port 36a and an opposing port or port 36b and an opposing port) may not be present. In some cases, only one port may be provided. Further, additional ports, such as, but not limited to, one or more Ethernet ports 38 may be provided.

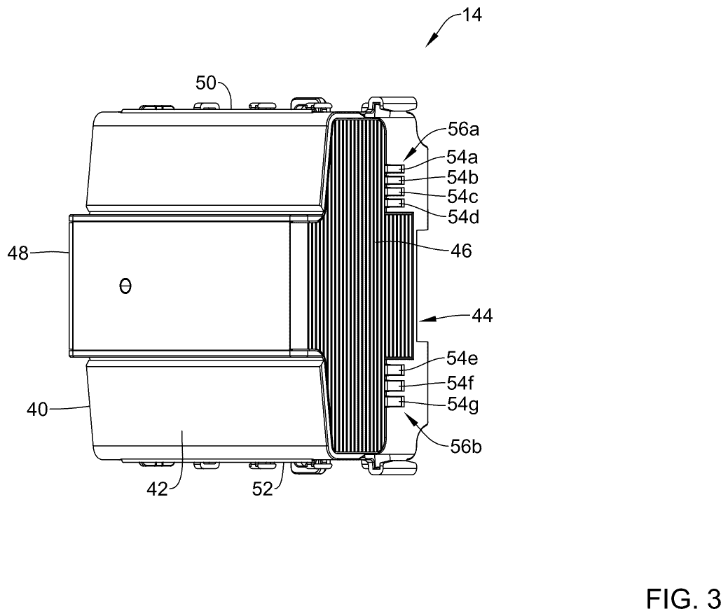

FIG. 3 is a perspective view of the illustrative I/O device 14 of FIG. 1. The I/O device 14 may include a housing 40 including a front side 42, a back side 44, and at least a first side 46, and a second opposing side 48. The first and second sides 46, 48 may each extend from or between the front 42 to the back 44. The housing 40 may further include a top 50 and an opposing bottom 52. The top and bottom 50, 52 may extend from or between the first and second sides 46, 48. The use of the terms “front”, “back”, “first”, “second”, “top”, and “bottom” are not intended to limit the I/O device 14 to a particular orientation, but rather to facilitate discussion of relative orientation. Further, the housing 40 is not limited to a rectangular or generally rectangular structure. Other shapes may be used for the housing 40, as desired. Some illustrative electronic devices and electrical connectors are described in commonly assigned U.S. patent application Ser. No. 16/837,579, filed on Apr. 1, 2020, and titled ELECTRICAL CONNECTOR FOR A CONTROLLER, and U.S. Patent Applicant Number 18/291,067, filed on Jan. 22, 2024, and titled HOT SWAP BASE FOR A BUILDING CONTROLLER, the disclosures of which are hereby incorporated by reference.

The illustrative I/O device 14 may include a printed circuit board (PCB) (not shown). The PCB may be completely or partially housed within the housing 40. While not explicitly shown, the PCB may include electrical and/or electronic components that may include control logic and/or communication capabilities. These components may be electrically connected to one another and mechanically fastened to the PCB. While not explicitly shown, the I/O device 14 may include pins, terminal connectors, etc. for coupling the PCB to other devices.

The illustrative I/O device 14 may include one or more electrical connectors 54a-g (collectively, 54). Each of the electrical connectors 54 may be electrically connected to the PCB (not shown) via a terminal receiving slot or other electrical connection (not explicitly shown) and may be configured to electrically couple the PCB of the I/O device 14 to other (e.g. external) devices. The I/O device 14 may include any number of electrical connectors 54 as desired. The electrical connectors 54 may be grouped together to form ports 56a-b (collectively, 56). In some cases, a first set of ports 56a-b may be formed on the first side 46 of the I/O device 14 and an opposing set of ports (not explicitly shown) may be formed on the second side 48 of the I/O device 14. For example, the number of electrical connectors 54 provided may depend on how the I/O device 14 is to be connected to another electronic device. For example, a first port type may require three electrical connectors to form a port 56b. A first electrical connector 54e of the port 56b may be for power, a second electrical connector 54f of the port 56b may be for ground, and a third electrical connector 54g of the port 56b may be for serial data. Another port type (e.g., RS485) may require six electrical connectors to form two ports 56a, 56b. The first port 56a may be for power while the second port 56b is for data. These are just examples. In some cases, the electrical connectors 54 may extend from a first terminal adjacent to or accessible from the first side 46 of the housing 40 to a second terminal adjacent to or accessible from the second side 48 of the housing 40 such that each group of electrical connectors (e.g., 54a-d and 54e-g) forms two ports, respectively. It should be understood that the ports 56a, 56b provided on the first side 46 may be connected to a first external device while the ports (not explicitly shown) on the second side 48 may be connected to a second, different external device. For example, the ports 56a, 56b may be for receiving an input and/or delivering an output from a first external device while the ports on the opposing side may be for receiving an input and/or delivering an output to a second or different external device. In some cases, only two of the ports may be provided. For example, two of the ports (e.g., port 56a and an opposing port or port 56b and an opposing port) may not be present. In some cases, only one port may be provided. Further, additional ports may be provided.

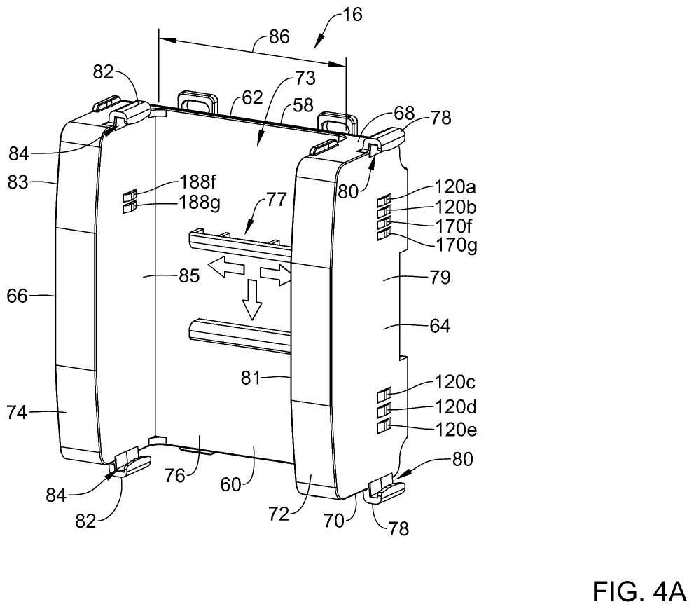

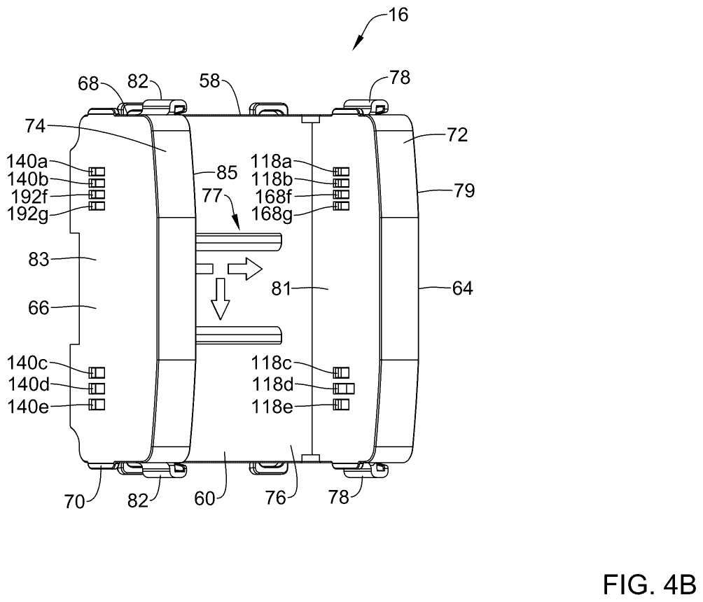

FIG. 4A is a perspective view of an illustrative but non-limiting receiving base 16, such as, but not limited to, a building controller receiving base from a first side and FIG. 4B is a perspective view of the illustrative receiving base 16 from a second side. Receiving base 18, shown in FIG. 1, may be similar in form and function to receiving base 16. The receiving base 16 may be configured to receive a controller (such as, but not limited to, a building controller), an I/O device, or any other electronic device. Generally, the receiving base 16 may be configured to provide different conduction paths based on a type of communication protocol used by the device that is received by the receiving base 16. The device received within the receiving base may be described as a building controller. However, it should be understood that other types of controllers, I/O devices, or other electronic devices may be received within the receiving base 16.

The receiving base 16 may include a housing 58 including a front side 60, a back side 62, and at least a first side 64, and a second opposing side 66. The first and second sides 64, 66 may each extend from or between the front 60 to the back 62. The housing 58 may further include a top 68 and an opposing bottom 70. The top and bottom 68, 70 may extend from or between the first and second sides 64, 66. The use of the terms “front”, “back”, “first”, “second”, “top”, and “bottom” are not intended to limit the housing 58 to a particular orientation, but rather to facilitate discussion of relative orientation. Further, the housing 58 is not limited to a rectangular or generally rectangular structure. Other shapes may be used for the housing 58, as desired.

The housing 58 may include a first raised end 72 adjacent the first side 64, a second raised end 74 adjacent the second side 66, and a base platform 76 extending laterally between an inner edge or inner surface of the first raised end 72 and an inner edge or inner surface of the second raised end 74. The first and second raised ends 72, 74 may be configured to project upward from the base platform 76 along the first and second sides 64, 66, respectively, of the housing 58. The first and second raised ends 72, 74 may have a thickness that is greater than a thickness of the base platform 76, but this is not required. As will be described in more detail herein, the first and second raised ends 72, 74 may be configured to mechanically and electrical couple to a building controller 12 or other component, such as I/O device 14 of FIG. 1. For example, the first and/or second raised ends 72, 74 may define a building controller, other controller, I/O device, or electronic device receiving slot 73 extending therebetween. At least one of the first and/or second raised ends 72, 74 may form a slot defining wall to define an end of the receiving slot 73. For example, when a controller 12 is secured to the housing 58, the first raised end 72 may extend along at least part of a first side 26 of the housing 20 of the controller 12 and the second raised end 74 may extend along a part of a second side 28 of the housing 20 of the controller 12. In some embodiments one of the first or second raised ends 72, 74 may be omitted. The receiving slot 73 may extend from the top 68 to the bottom 70 of the housing 58, but this is not required. The base platform 76 may be configured to mechanically and/or electrically couple to an electronic device and/or other component. For example, the base platform 76 may be configured to be coupled to a DIN rail or other mounting system of the received electronic device. For example, the base platform 76 may include one or more mounting features 77 configured to releasably engage one or more mating mounting features of the received electronic device. Some illustrative mounting features 77 may include, but are not limited to, mating slots and tabs, protrusions and recesses, friction fits, snap fits, or the like.

In some embodiments, the housing 58 may further include features configured to align and couple the receiving base 16 with another device, such as, but not limited to, an electronic device or another receiving base 18. For example, the housing 58 may include one or more interconnection structures 78 on the first raised end 72 that is configured to releasably couple with a mating structure, such as a tab on another device. The interconnection structure(s) 78 may be a generally “U” shaped bracket defining a slot 80. The slot 80 may be configured to slide over a tab on the adjacent electronic device or another receiving base to mechanically align and connect the two components. Similarly, the housing 58 may include one or more interconnection structures 82 on the second raised end 74 that is configured to releasably couple with a mating structure, such as a tab on another device. The interconnection structure(s) 82 may be a generally “U” shaped bracket defining a slot 84. The slot 84 may be configured to slide over a tab on the received electronic device to align and connect the two components. These are just examples. Other connection structures may be used as desired. In some cases, the interconnection structure(s) 78 on the first raised end 72 may be configured to be releasably coupled to an adjacent device or receiving base and the interconnection structure(s) 84 on the second raised end 74 may be configured to be releasably coupled with an electronic device received between the first and second raised ends 72, 74. In some cases, the interconnection structure 78 and 82 may not be present.

The base platform 76 may have a width that is configured to receive particular electronic devices having a corresponding width. In one example, the base platform 76 may have a width 86 of about 70 millimeters. In other examples, the base platform 76 may have a width 86 of about 105 millimeters. These are just examples, the width 86 of the base platform 76 may be less than 70 millimeters, less than 105 millimeters, or greater than 105 millimeters, as desired. It is contemplated that receiving bases of differing widths may be used to accommodate differing width electronic devices.

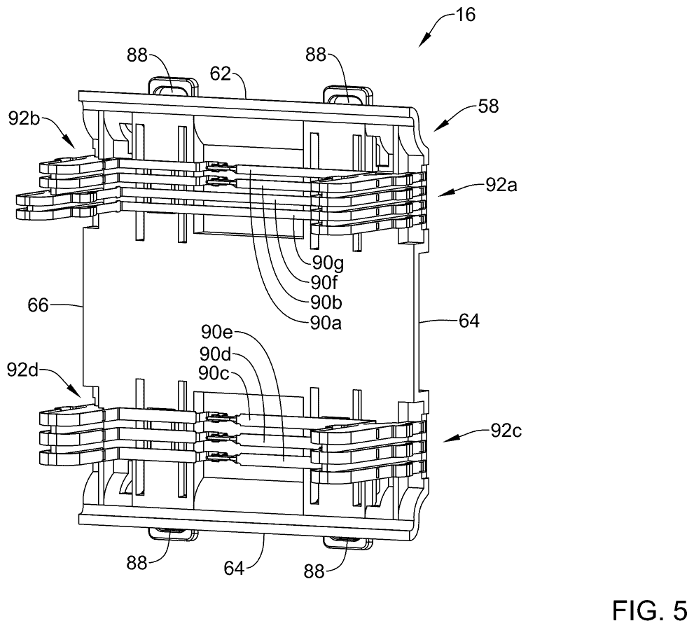

FIG. 5 is a perspective view of the illustrative receiving base 16 of FIG. 4A with the front 60 of the housing 58 removed. The illustrative receiving base 16 include one or more apertures 88 for receiving a fixation mechanism therethrough. For example, a fixation mechanism, such as, but not limited to a screw, bolt, etc. may be used to secure the receiving base 16 in a desired mounting surface. The illustrative receiving base 16 includes one or more electrical conductor assemblies 90a-g (collectively, 90). Each of the electrical conductor assemblies 90 may be configured to be electrically connected to an electronic device, such as a controller 12, I/O device, or the like and/or to another receiving base 18. The receiving base 16 may include any number of electrical conductor assemblies 90 as desired. The electrical conductor assemblies 90 may be grouped together as a first and second plurality of electrical conductor assemblies 90 to form ports 92a-d (collectively, 92). For example, the number of electrical conductor assemblies 90 provided may depend on the particular controller 12, I/O device 14, or other electrical device that the receiving base 16 is intended to receive and interface with. For example, a first port type may require three electrical connectors to form a port, with a first electrical connector of the port for conducting power, a second electrical connector of the port for conducting ground, and a third electrical connector of the port for conducting serial data. Another port type may have a first electrical connector of the port for conducting data (U+), a second electrical connector of the port for conducting data (U−), and a third electrical connector of the port for conducting ground (e.g., RS485). In another example, another port type may require two, three, four or more electrical connectors to form a port (e.g., TIL-Ethernet over twisted pair). These are just examples.

In some cases, the electrical conductor assemblies 90 may extend from the first side 64 of the housing 58 to the second side 66 of the housing 58 such that a first group of four electrical conductor assemblies 90a-d forms two ports 92a, 92b and a second group of three electrical conductor assemblies 90e-g forms two ports 92c, 92d. It should be understood that the ports 92a, 92c provided on the first side 64 may be connected to a first device or component while the ports 92b, 92d on the second side 66 may be connected to a second, different device or component, providing a pass-through connection through the receiving base 16. For example, the ports 92a, 92c may be for receiving an input and/or delivering an output from a first device while the ports 92b, 92d may be for receiving an input and/or delivering an output to a second or different device. In some cases, only two of the ports may be provided. For example, two of the ports (e.g., port 92a and port 92b or port 92c and port 92d) may not be present. In some cases, only one port may be provided.

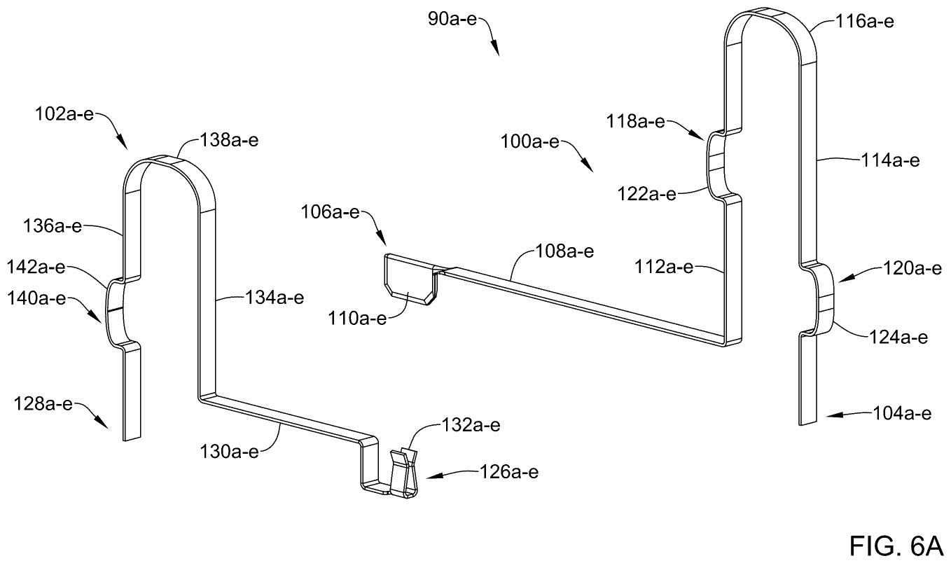

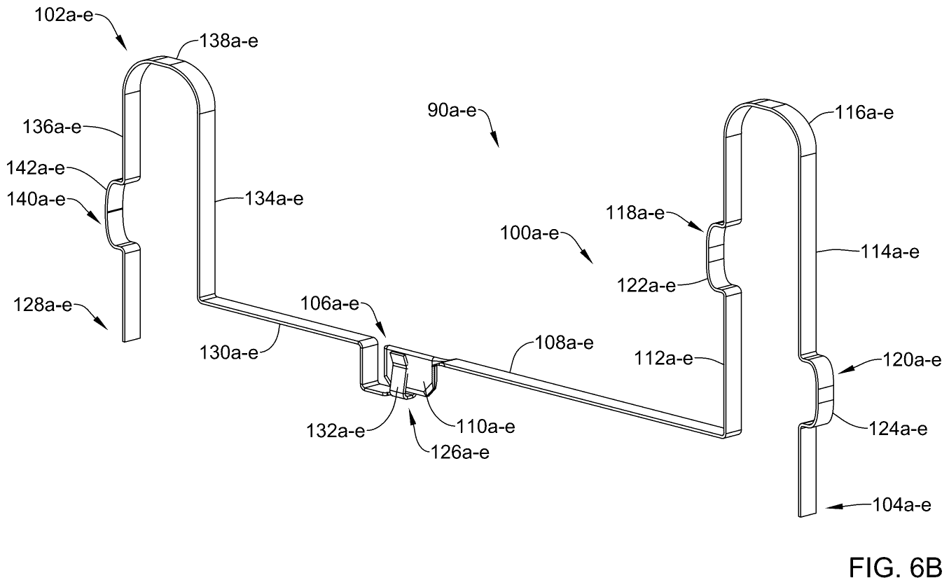

The electrical conductor assemblies 90 may have differing structures. For example, a first plurality of the electrical conductor assemblies 90a-e may have a first structure and a second plurality of the electrical conductor assemblies 90f-g may have a second structure different from the first structure. FIG. 6A is an exploded perspective view of one of the first plurality of electrical conductor assemblies 90a-e and FIG. 6B is an assembled perspective view of one of the first plurality of electrical conductor assemblies 90a-e. In the example shown, each electrical conductor assembly 90a-e may include a first member 100a-e and a second member 102a-e.

Generally, each electrical conductor assembly 90a-e may extend from a first terminal 120a-e (such as, but not limited to, a first touch flake or spring contact) accessible from the first side 64 of the housing 58 to a second terminal 140a-e (such as, but not limited to, a second touch flake or spring contact) accessible from the second side 66 of the housing 58. The first member 100a-e may extend from a first end 104a-e to a second end 106a-e. Each of the first members 100a-e may include a longitudinally extending base or electrically conductive bridge 108a-e. The electrically conductive bridge 108a-e may extend between and may be coupled to a terminal connection member 110a-e adjacent to the second end 106a-e of the first member 100a-e and a second arm 112a-e. The second arm 112a-e may extend generally orthogonal to the electrically conductive bridge 108a-e. However, the second arm 112a-e may extend at generally non-orthogonal angles to the electrically conductive bridge 108a-e, as desired. Each first member 100a-e may further include a first arm 114a-e adjacent to the first end 104a-e thereof and extending generally parallel to and spaced from the second arm 112a-e. The first arm 114a-e may be electrically and mechanically coupled to the second arm 112a-e via an interconnecting arm 116a-e such that the first arm 114a-e, the second arm 112a-e, and the interconnecting arm 116a-e form a generally “U” shape.

Each of the first members 100a-e may further include the first terminal or first touch flake or spring contact 120a-e. The first touch flake 120a-e may be formed in the first arm 114a-e. The first touch flake 120a-e may have a generally curved or “U” shape which allows it to flex under an applied force. For example, an intermediate region 124a-e of the first touch flake 120a-e may be axially spaced from the first arm 114a-e (e.g., in a direction away from the second arm 112a-e). When an applied force is exerted on the intermediate region 124a-e, the intermediate region 124a-e may flex in a direction towards the second arm 112a-e. The first touch flake 120a-e may extend through an opening in the outer side 79 of the of the first raised end 72 such that the second touch flake 120a-e is accessible from a location exterior to the housing 58 or exterior to the receiving slot 73, as shown in FIG. 4A.

The first members 100a-e may further include a third terminal or third touch flake or touch flake 118a-e. The third touch flake 118a-e may be formed in the second arm 112a-e. The third touch flake 118a-e may have a generally curved or “U” shape which allows it to flex under an applied force. For example, an intermediate region 122a-e of the third touch flake 118a-e may be axially spaced from the second arm 112a-e (e.g., in a direction away from the first arm 114a-e). When an applied force is exerted on the intermediate region 122a-e, the intermediate region 122a-e may flex in a direction towards the first arm 114a-e. The third touch flake 118a-e may extend through an opening in the inner side 81 of the first raised end 72 and may be configured to be accessible from a location within or interior to the receiving slot 73, as shown in FIG. 4B. Each touch flake 118a-e, 120a-e may be mechanically and electrically connected or coupled to and extend from the base or electrically conductive bridge 108a-e.

The first member 100a-e may be formed as a single monolithic structure. For example, each of the first members 100a-e may be stamped from a single monolithic electrically conductive material. In other cases, one or more of the touch flakes 118a-e, 120a-e, conductive bridge 108a-e, arms 112a-e, 114a-e, 116a-e, and/or terminal connection member 110a-e may be formed as a discrete structure and subsequently coupled to the other components. Some illustrative, but non-limiting, coupling techniques may include, but are not limited to, welding, soldering, brazing, etc.

The second member 102a-e may extend from a first end 126a-e to a second end 128a-e. Each of the second members 102a-e may include a longitudinally extending base or electrically conductive bridge 130a-e. The electrically conductive bridge 130a-e may extend between and may be coupled to a terminal receiving slot 132a-e adjacent to the first end 126a-e of the second member 102a-e and a first arm 134a-e. The terminal receiving slot 132a-e may be configured to receive the terminal connection member 110a-e of the first member 100a-e to mechanically and electrically couple the first and second members 100a-e, 102a-e of the electrical conductor assemblies 90a-e, as shown in FIG. 6B.

The first arm 134a-e may extend generally orthogonal to the electrically conductive bridge 130a-e. However, the first arm 134a-e may extend at generally non-orthogonal angles to the electrically conductive bridge 130a-e, as desired. Each second member 102a-e may further include a second arm 136a-e adjacent to the second end 128a-e thereof and extending generally parallel to and spaced from the first arm 134a-e. The second arm 136a-e may be electrically and mechanically coupled to the first arm 134a-e via an interconnecting arm 138a-e such that the first arm 134a-e, the second arm 136a-e, and the interconnecting arm 138a-e form a generally “U” shape.

Each of the second members 102a-e may further include the second terminal or second touch flake or spring contact 140a-e. The second touch flake 140a-e may be formed in the second arm 136a-e. The second touch flake 140a-e may have a generally curved or “U” shape which allows it to flex under an applied force. For example, an intermediate region 142a-e of the second touch flake 140a-e may be axially spaced from the second arm 136a-e (e.g., in a direction away from the first arm 134a-e). When an applied force is exerted on the intermediate region 142a-e, the intermediate region 142a-e may flex in a direction towards the first arm 134a-e. The second touch flake 140a-e may extend through an opening in the outer side 83 of the second raised end 74 such that the second touch flake 140a-e is accessible from a location exterior to the housing 58 or exterior to the receiving slot 73, as shown in FIG. 4B. Each touch flake 140a-e may be mechanically and electrically connected or coupled to and extend from the base or electrically conductive bridge 130a-e.

The second member 102a-e may be formed as a single monolithic structure. For example, each of the second members 102a-e may be stamped from a single monolithic electrically conductive material. In other cases, one or more of the touch flakes 140a-e, conductive bridge 130a-e, arms 134a-e, 136a-e, 138a-e, and/or terminal receiving slot 132a-e may be formed as a discrete structure and subsequently coupled to the other components. Some illustrative, but non-limiting, coupling techniques may include, but are not limited to, welding, soldering, brazing, etc. The terminals 118a-e, 120a-e, 140a-e may be positioned within or extend from the first and/or second raised ends 72, 74 while the electrically conductive bridges 108a-e, 130a-e may extend within the base platform 76.

It is contemplated that the first plurality of electrical conductor assemblies 90a-e may have a similar structure but may vary in size and/or positioning of some of the features. In one illustrative example, one or more of the touch flakes 118a-e, 120a-e, 140a-e may have differing sizes. For example, at least one of the electrical conductor assemblies 90d may have a third touch flake 118d that is longer than the third touch flakes 118a-c, 118e of other electrical conductor assemblies 90a-c, 90e (see, for example, FIG. 4B). This is just one example.

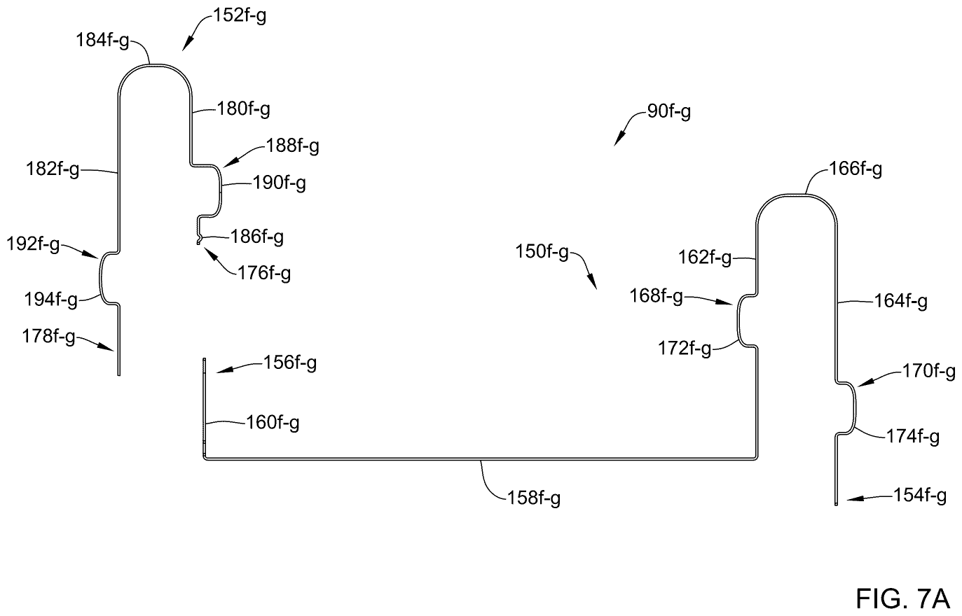

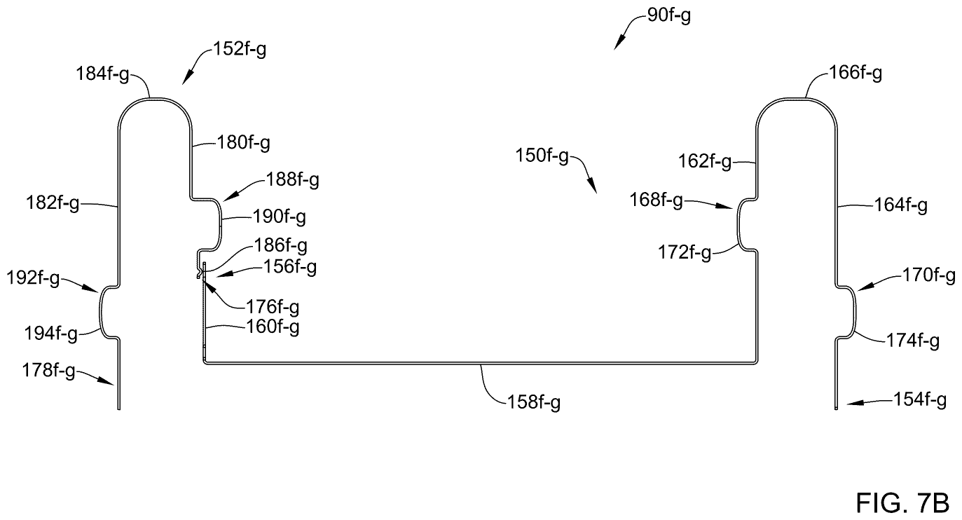

FIG. 7A is an exploded side view of one of the second plurality of electrical conductor assemblies 90f-g and FIG. 7B is an assembled side view of one of the second plurality of electrical conductor assemblies 90f-g. Generally, each electrical conductor assembly 90f-g may extend from a first terminal 170f-g (such as, but not limited to, a first touch flake or spring contact) accessible from the first side 64 of the housing 58 to a second terminal 192f-g (such as, but not limited to, a second touch flake or spring contact) accessible from the second side 66 of the housing 58. Each electrical conductor assembly 90f-g may include a first member 150f-g and a second member 152f-g. The first member 150f-g may extend from a first end 154f-g to a second end 156f-g. Each of the first members 150f-g may include a longitudinally extending base or electrically conductive bridge 158f-g. The electrically conductive bridge 158f-g may extend between and may be coupled to a third arm 160f-g adjacent to the second end 156f-g of the first member 150f-g and a second arm 162f-g. The third arm 160f-g may extend generally orthogonal to the electrically conductive bridge 158f-g. However, the third arm 160f-g may extend at generally non-orthogonal angles to the electrically conductive bridge 158f-g, as desired.

The second arm 162f-g may extend generally orthogonal to the electrically conductive bridge 158f-g. However, the second arm 162f-g may extend at generally non-orthogonal angles to the electrically conductive bridge 158f-g, as desired. Each first member 150f-g may further include a first arm 164f-g adjacent to the first end 154f-g thereof and extending generally parallel to and spaced from the second arm 162f-g. The first arm 164f-g may be electrically and mechanically coupled to the second arm 162f-g via an interconnecting arm 166f-g such that the second arm 162f-g, the first arm 164f-g, and the interconnecting arm 166f-g form a generally “U” shape.

Each of the first members 150f-g may further include the first terminal or first touch flake or spring contact 170f-g. The first touch flake 170f-g may be formed in the first arm 164f-g. The first touch flake 170f-g may have a generally curved or “U” shape which allows it to flex under an applied force. For example, an intermediate region 174f-g of the first touch flake 170f-g may be axially spaced from the first arm 164f-g (e.g., in a direction away from the second arm 162f-g). When an applied force is exerted on the intermediate region 174f-g, the intermediate region 174f-g may flex in a direction towards the second arm 162f-g. The first touch flake 170f-g may extend through an opening in the outer side 79 of the first raised end 72 such that the second touch flake 170f-g is accessible from a location exterior to the housing 58 or exterior to the receiving slot 73, as shown in FIG. 4A.

The first members 150f-g may further include a third terminal or third touch flake or spring contact 168f-g. In some cases, the third touch flake 168f-g may be a first slot touch flake 168f-g in that the terminal is positioned within the receiving slot 73. The third touch flake 168f-g may be formed in the second arm 162f-g. The third touch flake 168f-g may have a generally curved or “U” shape which allows it to flex under an applied force. For example, an intermediate region 172f-g of the third touch flake 168f-g may be axially spaced from the second arm 162f-g (e.g., in a direction away from the first arm 164f-g). When an applied force is exerted on the intermediate region 172f-g, the intermediate region 172f-g may flex in a direction towards the first arm 164f-g. The third touch flake 168f-g may extend through an opening in the inner side 81 of the first raised end 72 and may be configured to be accessible from a location within or interior to the receiving slot 73, as shown in FIG. 4B. Each touch flake 168f-g, 170f-g may be mechanically and electrically connected or coupled to and extend from the base or electrically conductive bridge 158f-g.

The first member 150f-g may be formed as a single monolithic structure. For example, each of the first members 150f-g may be stamped from a single monolithic electrically conductive material. In other cases, one or more of the touch flakes 168f-g, 170f-g, conductive bridge 158f-g, and/or arms 160f-g, 162f-g, 164f-g, 166f-g, may be formed as a discrete structure and subsequently coupled to the other components. Some illustrative, but non-limiting, coupling techniques may include, but are not limited to, welding, soldering, brazing, etc.

The second member 152f-g may extend from a first end 176f-g to a second end 178f-g. Each of the second members 152f-g may include a first arm 180f-g, a second arm 182f-g, and an interconnecting arm 184f-g. The second arm 182f-g may be adjacent to the second end 178f-g of the second member 152f-g and may extend generally parallel to and spaced from the first arm 180f-g. The second arm 182f-g may be electrically and mechanically coupled to the first arm 180f-g via an interconnecting arm 184f-g such that the first arm 180f-g, the second arm 182f-g, and the interconnecting arm 184f-g form a generally “U” shape. The first arm 180f-g may extend generally parallel to the third arm 160f-g of the first member 150f-g. The first arm 180f-g may further include a bump or curved portion 186f-g adjacent to a free end thereof. The curved portion 186f-g may be a curve in the first arm 180f-g extending away from the second arm 182f-g and configured to be in selective mechanical and electrical engagement with the third arm 160f-g of the first member 150f-g. As can be seen in FIG. 7B, the curved portion 186f-g contacts the third arm 160f-g of the first member 150f-g when the second member 152f-g is in a first or unbiased configuration.

Each of the second members 152f-g may further include a fourth terminal or fourth touch flake or spring contact 188f-g. In some cases, the fourth touch flake 188f-g may be a second slot touch flake 188f-g in that the terminal is positioned within the receiving slot 73 of the receiving base 16. The fourth touch flake 188f-g may be formed in the first arm 180f-g. The fourth touch flake 188f-g may have a generally curved or “U” shape which allows it to flex under an applied force. For example, an intermediate region 190f-g of the fourth touch flake 188f-g may be axially spaced from the first arm 180f-g (e.g., in a direction away from the second arm 182f-g). When an applied force is exerted on the intermediate region 190f-g, the intermediate region 190f-g may flex in a direction towards the second arm 182f-g. In some cases, an applied force exerted on the intermediate region 190f-g may deflect the curved region 186f-g and the free end of the first arm 180f-g towards the second arm 182f-g, electrically and mechanically disconnecting the free end of the first arm 180f-g from the second end 156f-g of the corresponding first member 150f-g. The fourth touch flake 188f-g may extend through an opening in the inner side 85 of the second raised end 74 and may be configured to be accessible from a location within or interior to the receiving slot 73, as shown in FIG. 4A.

The second members 152f-g may further include the second terminal or second touch flake or spring contact 192f-g. The second touch flake 192f-g may be formed in the second arm 182f-g. The second touch flake 192f-g may have a generally curved or “U” shape which allows it to flex under an applied force. For example, an intermediate region 194f-g of the fourth touch flake 192f-g may be axially spaced from the second arm 182f-g (e.g., in a direction away from the first arm 180f-g). When an applied force is exerted on the intermediate region 194f-g, the intermediate region 194f-g may flex in a direction towards the first arm 180f-g. The second touch flake 192f-g may extend through an opening in the outer side 83 of the second raised end 74 such that the second touch flake 192f-g is accessible from a location exterior to the housing 58 or exterior to the receiving slot 73, as shown in FIG. 4B.

The second member 152f-g may be formed as a single monolithic structure. For example, each of the second members 152f-g may be stamped from a single monolithic electrically conductive material. In other cases, one or more of the touch flakes 188f-g, 192f-g, and/or arms 180f-g, 182f-g, 184f-g, and/or portions thereof may be formed as a discrete structure and subsequently coupled to the other components. Some illustrative, but non-limiting, coupling techniques may include, but are not limited to, welding, soldering, brazing, etc. The terminals 168f-g, 170f-g, 188f-g, 192f-g may be positioned within or extend from the first and/or second raised ends 72, 74 while the electrically conductive bridge 158f-g may extend within the base platform 76.

As described above, the electrical conductor assemblies 90a-g may be grouped to form one or more ports 92a-d. In some cases, a first group of electrical conductor assemblies 90a-b, 90f-g may be configured to transmit data or an electrical signal while a second group of electrical conductor assemblies 90c-e may be configured to supply power. For example, the second group of electrical conductor assemblies 90c-e may include an earth ground, 24+,and 24−. This is just an example. When the receiving base 16 is free from receiving a controller 12, I/O device 14, or other electronic device, the electrical conductor assemblies 90a-g may pass power and/or electrical signals from a first side 64 of the receiving base 16 to a second side 66 of the receiving base 16 or, alternatively, from the second side 66 to the first side 64.

Inserting a building controller 12 (or other electronic device), into the slot 73 of the receiving base 16 may electrically couple the ports 92a-d of the receiving base 16 with the corresponding ports 36a-d of the building controller 12. In some cases, the receiving base 16 may be configured to receive different types of electronic devices that use, for example, different communication protocols. In one illustrative example, the receiving base 16 may be configured to accept or receive electronic devices that use either the RS485 or the TIL communication protocol to communicate with other devices. However, it is contemplated that the receiving base 16 may be configured to receive electronic devices using other communication protocols, as desired. In some cases, electronic devices with differing communication protocols may require different mechanical and/or electrical paths through the receiving base 16.

Generally, the receiving base 16 may be configured such that when the receiving slot 73 receives a building controller 12 of a first type (e.g., a first building controller type using TIL communication), the building controller of the first type deflects a deflectable part of the conductor assembly to form an electrical break in a conduction path between a first terminal accessible from the first side of the housing and a second terminal accessible from the second side of the housing. For example, a touch flake or other contact of the building controller of the first type may contact and deflect the fourth touch flake 188f-g of the second member 152f-g of the second plurality of electrical conductor assemblies 90f-g. Deflection of the fourth touch flake 188f-g of the second member 152 may cause the free end of the first arm 180f-g thereof to move away from the third arm 160f-g of the first member 150f-g such that a mechanical and electrical gap is present between the first member 150f-g and the second member 152f-g. This may form an electrical break in the electrical path extending between the first end 154f-g of the first member 150f-g and the second end 178f-g of the second member (e.g., an electrical break between the first terminal or touch flake 170f-g accessible from the first side 64 of the housing 58 of the receiving base 16 and the second terminal or touch flake 192f-g accessible from the second side 66 of the housing 58 of the receiving base 16).

Said differently, when the building controller receiving slot 73 receives a building controller 12 of a first building controller type, the building controller 12 of the first building controller type may be configured to engage the first slot touch flake 168f-g and the second slot touch flake 188f-g. The second slot touch flake 188f-g, when engaged, may deflect a deflectable part 180f-g of the conductor assembly 90f-g. With the deflectable part 180f-f-g of the conductor assembly 90f-g deflected, the conductor assembly 90f-g may be configured to electrically connect the first touch flake 170f-g and the first slot touch flake 168f-g, electrically connect the second slot touch flake 188f-g and the second touch flake 192f-g, and electrically disconnect the first touch flake 170f-g and the first slot touch flake 168f-g from the second slot touch flake 188f-g and the second touch flake 192f-g. This is useful when using, for example the TIL communication protocol, where the building controller of the first building controller type receives TIL input signals via input terminals of the building controller, processes the input signals and provided output signals via output terminals of the building controller. Without electrically disconnect the first touch flake 170f-g and the first slot touch flake 168f-g from the second slot touch flake 188f-g and the second touch flake 192f-g, the input terminals and the output terminals of the building controller would be shorted out.

However, when the building controller receiving slot 73 receives a building controller 12 of a second building controller type, the building controller 12 of the second building controller type may be configured to engage the first slot touch flake 168f-g but not the second slot touch flake 188f-g. The second slot touch flake 188f-g, when not engaged, does not deflect the deflectable part 180f-g of the conductor assembly 90f-g. Without electrically disconnect the first touch flake 170f-g and the first slot touch flake 168f-g from the second slot touch flake 188f-g and the second touch flake 192f-g, the electrical conductor assemblies 90f-g provide a bus, which the building controller 12 of the second building controller type may inject serial data (e.g. using RS485 communication).

When the building controller receiving slot 73 does not receive any building controller 12, the second slot touch flake 188f-g does not deflect the deflectable part 180f-g of the conductor assembly 90f-g. Without electrically disconnect the first touch flake 170f-g and the first slot touch flake 168f-g from the second slot touch flake 188f-g and the second touch flake 192f-g, the electrical conductor assemblies 90f-g provide a bypass communication path through the receiving base 16.

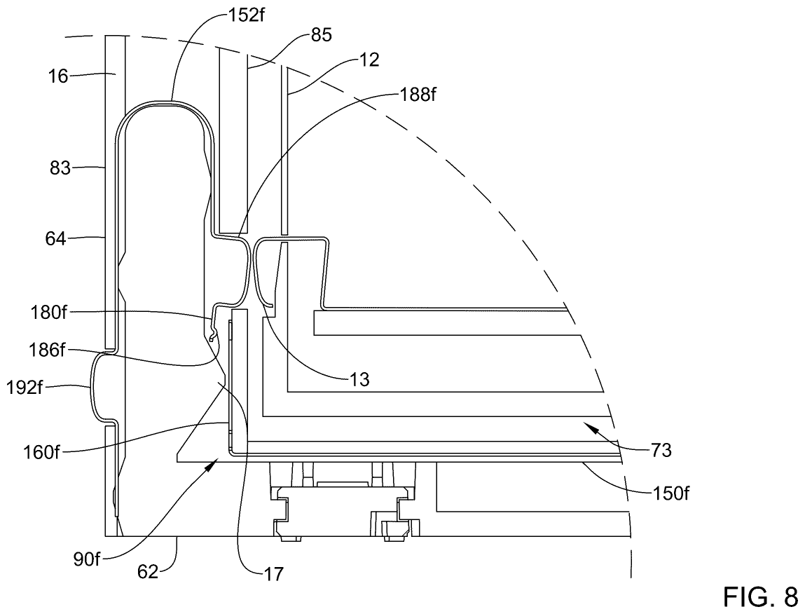

FIG. 8 is a schematic partial cross-sectional view of a building controller 12 of the first type received within the receiving slot 73 of the receiving base 16. When the building controller receiving slot 73 receives the building controller 12 of the first building controller type, the third touch flake 168f-g and the fourth touch flake 188f-g are configured to electrically and mechanically engage a first port 36a and a second port (not explicitly shown) of the building controller 12 of the first building controller type, respectively. As can be seen, a touch flake 13 of the building controller 12 contacts the fourth terminal or touch flake 188f.

The touch flake 13 of the building controller 12 exerts a force or biases the fourth touch flake 188f of the conductor assembly 90f away from the third arm 160f of the first member 150f to break the electrical connection. In some cases, the receiving base 16 may include a feature, such as, but not limited to, a protrusion 17 configured to maintain the third arm 160f in a fixed orientation as the first arm 180f of the second member 152f is deflected. Further, the protrusion 17 may provide a space within the housing 58 to allow for movement of the first arm 180f of the second member 152f.

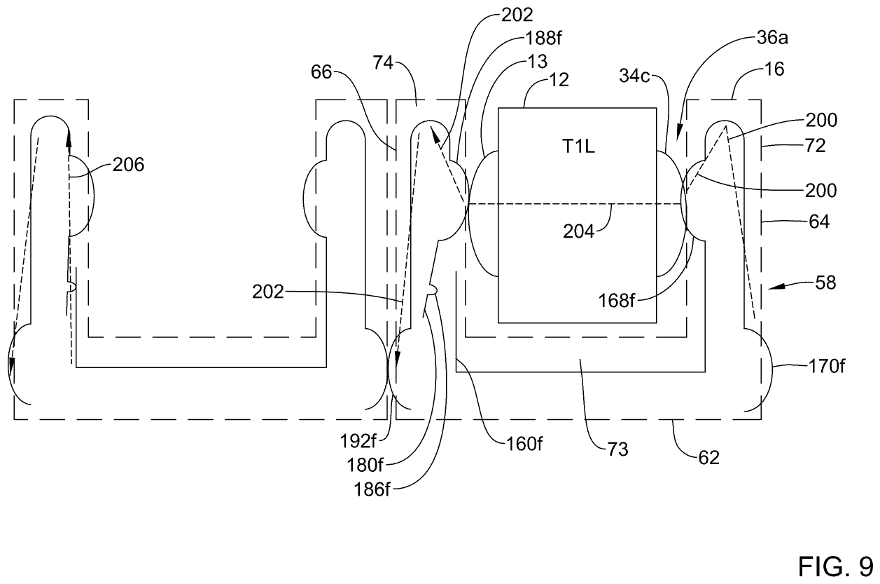

FIG. 9 is a schematic view of an illustrative receiving base 16 having a building controller 12 of the first type disposed within the receiving slot 73 and electrically coupled with another receiving base 18 free from an electronic device. When the receiving slot 73 of the receiving base 16 receives the building controller 12 of the first type, the second plurality of conductor assemblies 90f-g may provide a first conduction path 200 from a first terminal (e.g., first touch flake 170f-g) accessible from the first side 64 of the housing 58 to a first port 36a of the building controller 12 of the first building controller type, and provides a second conduction path 202 from the second terminal (e.g., second touch flake 192f-g) accessible from the second side 66 of the housing 58 to a second port 13 of the building controller 12 of the first type. As shown, the building controller 12 of the first type deflects a deflectable part of the conductor assembly that electrically disconnects the conduction path between the first terminal 170f-g and the second terminal 192f-g. With the conduction path between the first terminal 170f-g and the second terminal 192f-g electrically disconnected, communication logic (e.g. T1L logic) of the building controller 12 can controls communication between the first and second conduction paths 200, 202. Said differently, the second plurality of conductor assemblies 90f-g of the receiving base 16 may provide an electrical connection to one or more terminals or ports 36a of the building controller 12 such that the building controller 12 of the first building controller type is electrically connected to both the first terminal 170f-g accessible from the first side 64 of the housing 58 and the second terminal 192f-g accessible from the second side 66 of the housing 58, with the building controller 12 controlling communication between the first and second conduction paths 200, 202.

The receiving base 16 may be further configured such that when the receiving slot 73 receives a building controller 12 or other electronic device of a second type (e.g., a second building controller type using RS485 communication), the building controller 12 of the second type does not deflect a deflectable part of the conductor assembly such that the conductor assembly 90a-g maintains the conduction path between the first terminal 170f-g and the second terminal 192f-g. For example, the building controller 12 of the second type may include touch flakes configured to contact the third touch flakes 168f-g and/or the third touch flakes 122a-e. Said differently, when the building controller receiving slot 73 receives the building controller 12 of the second building controller type, the third touch flake 168f-g is configured to electrically and mechanically engage a port of the building controller 12 of the second building controller type, while the fourth touch flake 188f-g is configured to not be mechanically engaged by the building controller 12 of the second building controller type. The electrical signal may pass through the conductor assemblies 90a-g from the first end 104a-e, 154f-g to the second end 128a-e, 178f-g where the electrical signal is passed to another device or receiving base via the second touch flake 140a-e on the first plurality of electrical conductor assemblies 90a-e or the second touch flake 192f-g on the second plurality of electrical conductor assemblies 90f-g.

When the receiving slot 73 receives the electronic device of the second electronic device type, the conductor assemblies 90f-g may provide an electrical connection to a port of the building controller 12 of the second electronic device type such that the port of the building controller 12 of the second type is electrically connected to both the first terminal 170f-g accessible from the first side 64 of the housing 58 and a second terminal 192f-g accessible from the second side 66 of the housing 58 through the conduction path. In some cases, the electronic device of the second electronic device type uses a port of the electronic device of the second electronic device type to provide communication signals along a communication path having a second communication protocol (e.g. RS485) between the first terminal accessible from the first side of the housing and the second terminal accessible from the second side of the housing.

Said differently when the building controller receiving slot 73 receives a building controller 12 of a second building controller type, the building controller 12 of the second building controller type is configured to engage the first slot touch flake 168f-g but not engage the second slot touch flake 188f-g so that the second slot touch flake 188f-g does not deflect the deflectable part 180f-g of the conductor assembly 90f-g. With the deflectable part 180f-g of the conductor assembly 90f-g not deflected, the conductor assembly 90f-g may be configured to electrically connect the first touch flake 170f-g, the first slot touch flake 168f-g, the second slot touch flake 188f-g, and the second touch flake 192f-g.

Those skilled in the art will recognize that the present disclosure may be manifested in a variety of forms other than the specific embodiments described and contemplated herein. Accordingly, departure in form and detail may be made without departing from the scope and spirit of the present disclosure as described in the appended claims.

What is claimed is:

1. A building controller receiving base for receiving a building controller, comprising:
a housing having a first side and an opposing second side;
the housing defining a building controller receiving slot for receiving a building controller, the building controller receiving slot situated between the first side and the second side of the housing and defined at least in part by a slot defining wall; and
a conductor assembly, wherein:
when the building controller receiving slot receives a building controller of a first building controller type, the building controller of the first building controller type deflects a deflectable part of the conductor assembly to form an electrical break in a conduction path between a first terminal accessible from the first side of the housing and a second terminal accessible from the second side of the housing; and
when the building controller receiving slot receives a building controller of a second building controller type, the building controller of the second building controller type does not deflect the deflectable part of the conductor assembly such that the conductor assembly maintains the conduction path between the first terminal and the second terminal.

2. The building controller receiving base of claim 1, wherein when the building controller receiving slot receives the building controller of the first building controller type, the conductor assembly provides a first conduction path from the first terminal accessible from the first side of the housing to a first port of the building controller of the first building controller type, and provides a second conduction path from the second terminal accessible from the second side of the housing to a second port of the building controller of the first building controller type.

3. The building controller receiving base of claim 2, wherein when the building controller receiving slot receives the building controller of the second building controller type, the conductor assembly provides an electrical connection to a port of the building controller of the second building controller type such that the port of the building controller of the first building controller type is electrically connected to both the first terminal accessible from the first side of the housing and the second terminal accessible from the second side of the housing through the conduction path.

4. The building controller receiving base of claim 3, wherein the deflectable part of the conductor assembly includes a touch flake that extends into the building controller receiving slot, wherein when the building controller of the first building controller type is inserted into the building controller receiving slot, one of the first port and second port of the building controller of the first building controller type is configured to electrically engage the touch flake and mechanically deflect the deflectable part of the conductor assembly to electrically break the conduction path between the first terminal accessible from the first side of the housing and the second terminal accessible from the second side of the housing.

5. The building controller receiving base of claim 3, wherein:
the building controller of the first building controller type uses the first port and the second port of the building controller of the first building controller type to provide communication signals along a communication path having a first communication protocol between the first terminal accessible from the first side of the housing and the second terminal accessible from the second side of the housing; and
the building controller of the second building controller type uses the port of the building controller of the second building controller type to provide communication signals along a communication path having a second communication protocol between the first terminal accessible from the first side of the housing and the second terminal accessible from the second side of the housing.

6. The building controller receiving base of claim 5, wherein the first communication protocol is TIL, and the second communication protocol is RS485.

7. The building controller receiving base of claim 1, comprising:
the first terminal comprises a first touch flake extending out from the first side of the housing;
the second terminal comprises a second touch flake extending out from the second side of the housing; and
a third touch flake electrically coupled to the first terminal extending into the building controller receiving slot.

8. The building controller receiving base of claim 7, comprising:
a fourth touch flake electrically coupled to the second terminal extending into the building controller receiving slot.

9. The building controller receiving base of claim 8, wherein:
when the building controller receiving slot receives the building controller of the first building controller type, the third touch flake and the fourth touch flake are configured to electrically and mechanically engage a first port and a second port of the building controller of the first building controller type, respectively; and
when the building controller receiving slot receives the building controller of the second building controller type, the third touch flake is configured to electrically and mechanically engage a port of the building controller of the second building controller type, while the fourth touch flake is configured to not be mechanically engaged by the building controller of the second building controller type.

10. A method for receiving a building controller in a building controller receiving base, the method comprising:
receiving a building controller of a building controller by the building controller receiving base, wherein:
when the building controller is of a first building controller type, deflecting a deflectable part of a conductor assembly of the building controller receiving base to electrically break a conduction path between a first terminal accessible from a first side of the building controller receiving base and a second terminal accessible from a second side of the building controller receiving base; and
when the building controller is of a second building controller type, not deflecting the deflectable part of a conductor assembly of the building controller receiving base to not electrically break the conduction path between the first terminal accessible from the first side of the building controller receiving base and the second terminal accessible from the second side of the building controller receiving base.

11. The method of claim 10, wherein:
when the building controller is of the first building controller type, the conductor assembly providing a first conduction path from the first terminal accessible from the first side of the building controller receiving base to a first port of the building controller of the first building controller type, and providing a second conduction path from the second terminal accessible from the second side of the building controller receiving base to a second port of the building controller of the first building controller type.

12. The method of claim 11, wherein:
when the building controller is of the second building controller type, the conductor assembly providing an electrical connection to a port of the building controller of the second building controller type such that the port of the building controller of the first building controller type is electrically connected to both the first terminal accessible from the first side of the building controller receiving base and the second terminal accessible from the second side of the building controller receiving base through the conduction path.

13. The method of claim 12, wherein:
the building controller of the first building controller type using the first port and the second port of the building controller of the first building controller type to provide communication signals along a communication path having a first communication protocol between the first terminal accessible from the first side of the building controller receiving base and the second terminal accessible from the second side of the building controller receiving base; and
the building controller of the second building controller type using the port of the building controller of the second building controller type to provide communication signals along a communication path having a second communication protocol between the first terminal accessible from the first side of the building controller receiving base and the second terminal accessible from the second side of the building controller receiving base.

14. The method of claim 13, wherein the first communication protocol is TIL and the second communication protocol is RS485.

15. The method of claim 11, wherein:
the first terminal of the building controller receiving base comprises a first touch flake extending out from the first side of the building controller receiving base;
the second terminal of the building controller receiving base comprises a second touch flake extending out from the second side of the building controller receiving base;
a third touch flake electrically coupled to the first terminal of the building controller receiving base and configured to electrically connect to the first port of the building controller of the first building controller type; and
a fourth touch flake electrically coupled to the second terminal of the building controller receiving base and configured to electrically connect to the second port of the building controller of the first building controller type.

16. A building controller receiving base for receiving a building controller, comprising:
a housing having a first side and an opposing second side;
the housing defining a building controller receiving slot for receiving a building controller, the building controller receiving slot situated between the first side and the second side of the housing and defined at least in part by a slot defining wall;
a first touch flake extending out from the first side of the housing;
a second touch flake extending out from the second side of the housing;
a first slot touch flake extending out from the slot defining wall and into the building controller receiving slot;
a second slot touch flake extending out from the slot defining wall and into the building controller receiving slot; and
a conductor assembly, wherein:
when the building controller receiving slot receives a building controller of a first building controller type, the building controller of the first building controller type is configured to engage the first slot touch flake and the second slot touch flake, and the second slot touch flake when engaged deflects a deflectable part of the conductor assembly, and with the deflectable part of the conductor assembly deflected, the conductor assembly is configured to:
electrically connect the first touch flake and the first slot touch flake;
electrically connect the second slot touch flake and the second touch flake;
electrically disconnect the first touch flake and the first slot touch flake from the second slot touch flake and the second touch flake; and
when the building controller receiving slot receives a building controller of a second building controller type, the building controller of the second building controller type is configured to engage the first slot touch flake but not engage the second slot touch flake so that the second slot touch flake does not deflect the deflectable part of the conductor assembly, and with the deflectable part of the conductor assembly not deflected, the conductor assembly is configured to electrically connect the first touch flake, the first slot touch flake, the second slot touch flake and the second touch flake.

17. The building controller receiving base of claim 16, wherein when the building controller receiving slot receives the building controller of the first building controller type, the first slot touch flake is configured to electrically connect to a first port of the building controller of the first building controller type, and the second slot touch flake is configured to electrically connect to a second port of the building controller of the first building controller type.

18. The building controller receiving base of claim 17, wherein when the building controller receiving slot receives the building controller of the second building controller type, the first slot touch flake is configured to electrically connect to a port of the building controller of the second building controller type, and the second slot touch flake is configured to not electrically or mechanically engage the building controller of the second building controller type.

19. The building controller receiving base of claim 18, wherein:
the building controller of the first building controller type is configured to use the first port and the second port of the building controller of the first building controller type to provide communication signals along a communication path having a first communication protocol between the first touch flake and the second touch flake; and
the building controller of the second building controller type is configured to use the first port of the building controller of the second building controller type to provide communication signals along a communication path having a second communication protocol between the first touch flake and the second touch flake.

20. The building controller receiving base of claim 19, wherein the first communication protocol is TIL and the second communication protocol is RS485.
